(19) United States
(12) Patent Application Publication
(10) Pub. No.: US 2016/0350146 A1
(43) Pub. Date: Dec. 1, 2016

(54) OPTIMIZED HADOOP TASK SCHEDULER IN AN OPTIMALLY PLACED VIRTUALIZED HADOOP CLUSTER USING NETWORK COST OPTIMIZATIONS

(71) Applicant: CISCO TECHNOLOGY, INC., San Jose, CA (US)

(72) Inventors: Yathiraj B. Udupi, San Jose, CA (US); Debojyoti Dutta, Santa Clara, CA (US); Madhav V. Marathe, Cupertino, CA (US); Raghunath O. Nambiar, San Ramon, CA (US)

(73) Assignee: CISCO TECHNOLOGY, INC., San Jose, CA (US)

(21) Appl. No.: 14/726,336

(22) Filed: May 29, 2015

(51) Int. Cl. G06F 9/455; H04L 12/911; H04L 12/14

(52) U.S. Cl. CPC G06F 9/45558; H04L 12/141; H04L 12/1442; H04L 47/783; G06F 2009/45595

(57) ABSTRACT

The present disclosure describes, among other things, a method for optimizing task scheduling in an optimally placed virtualized cluster using network cost optimizations. The method comprises computing a first network cost matrix for a plurality of available physical nodes, determining a first solution to a first optimization problem of virtual machine placement onto the plurality of available physical nodes based on the first network cost matrix, wherein the first solution comprises one or more optimally placed virtual machines, computing a second network cost matrix for allocating one or more tasks to one or more possible optimally placed virtual machines of the first solution, and determining a second solution to a second optimization problem of task allocation onto one or more possible optimally placed virtual machines of the first solution based on the second network cost matrix.

### TECHNICAL FIELD

This disclosure relates in general to the field of communications and, more particularly, to optimizing Hadoop task scheduling in an optimally placed virtualized Hadoop cluster using network cost optimizations.

### BACKGROUND

Computer networking technology allows execution of complicated computing tasks by sharing the work among the various hardware resources within the network. This resource sharing facilitates computing tasks that were previously too burdensome or impracticable to complete. Big data has been coined as a term for describing collection of data sets that are extremely large and complex. Many of these systems for understanding these datasets require a sophisticated architecture of machines to store and process the data. Architectures and solutions aimed for big data workloads run on virtualized machines/environments in a data center. Improving the performance of such workloads have been a topic of research in recent years.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates the process for MapReduce having map tasks and reducer tasks being performed in a virtualized computing environment, according to some embodiments of the disclosure;

FIG. 2 is a flow diagram which illustrates a method for optimizing task scheduling in an optimally placed virtualized cluster using network cost optimizations, according to some embodiments of the disclosure;

FIG. 3 shows an illustrative system for optimizing task scheduling in an optimally placed virtualized cluster using network cost optimizations, according to some embodiments of the disclosure;

FIG. 4 shows an illustrative cost matrix for a plurality of available physical hosts, according to some embodiments of the disclosure;

FIG. 5 shows an illustrative cost matrix for allocating one or more tasks to one or more possible optimally placed virtual machines, according to some embodiments of the disclosure; and

FIG. 6 shows an illustrative variable matrix for allocating one or more tasks to one or more possible optimally placed virtual machines, according to some embodiments of the disclosure.

### DETAILED DESCRIPTION OF EXAMPLE EMBODIMENTS

### Overview

The present disclosure describes, among other things, a method for optimizing task scheduling in an optimally placed virtualized cluster using network cost optimizations. The method comprises computing a first network cost matrix for a plurality of available physical nodes, determining a first solution to a first optimization problem of virtual machine placement onto the plurality of available physical nodes based on the first network cost matrix, wherein the first solution comprises one or more optimally placed virtual machines, computing a second network cost matrix for allocating one or more tasks to one or more possible optimally placed virtual machines of the first solution, and determining a second solution to a second optimization problem of task allocation onto one or more possible optimally placed virtual machines of the first solution based on the second network cost matrix.

In some embodiments, the first optimization problem is a non-linear optimization problem. Rows and columns of the first network cost matrix are both indexed by available physical nodes; entries of the first network cost matrix comprises network costs between possible pairs of physical nodes. Determining the first solution can include minimizing an objective function which calculates an aggregate network cost of possible data transfers between a selected subset of physical hosts to determine one or more physical hosts for creating a number of optimally placed virtual machines. In some cases, determining the first solution comprises minimizing an aggregate network cost of possible data transfers between a selected subset of physical hosts subject to a constraint that a total number of selected subset of physical hosts in the first solution has the capacity to create a desired number of optimally placed virtual machines.

In some embodiments, the second optimization problem is a linear programming based constraint optimization problem. Rows and columns of the second network cost matrix are indexed by the one or more optimally placed virtual machines and the one or more tasks; entries of the second network cost matrix comprises network costs, each network cost comprises a measure of data transfer time of moving data from a data split node to a particular physical node having a selected optimally placed virtual machine thereon to perform a particular task. Determining the second solution can include minimizing an objective function which calculates an aggregate network cost for performing the one or more tasks allocated respectively to a selected subset of optimally placed virtual machines. In some cases, determining the second solution comprises minimizing an aggregate network cost for task allocation subject to one or more constraints. For example, one or more constraints can include one or more of: a first constraint ensuring each one of the one or more optimally placed virtual machine in the second solution has a number of allocated tasks which is less than or equal to a maximum number of tasks allowed for a particular optimally placed virtual machine; and a second constraint ensuring, in the second solution, that a task is allocated to only one optimally placed virtual machine.

### Example Embodiments

### Understanding Basics of Hadoop in a Virtualized Computing Environment and its Performance Challenges

Processing big data can be done in many ways, and one popular way of processing big data is through deploying distributed storage and distributed processing in a virtualized computing environment. A virtualized computing environment can be managed using a cloud computing software platform, such as Openstack or other Infrastructure as a Service (IaaS) solutions. Virtual machines (VMs) can be created on physical nodes to provide a virtualized computing cluster using commodity hardware. Another software platform, e.g., Apache Hadoop, can be deployed in the virtualized computing environment to provide deployment for distributed storage and distributed processing of very large data sets.

As an example, in a typical Apache Hadoop deployment, compute nodes (e.g., VMs placed on physical nodes) handle the tasks of mapping and reducing, and data nodes store data on which the mappers and reducers operate. When these big data workloads (comprising many tasks) are run in a virtualized cloud environment, these compute nodes run on VMs that are created or spawned on physical servers (hosts) that are available in the datacenter. The data may reside on the physical storage that could be standalone storage servers or the same physical servers on which the VMs are running. Typically data resides on block storage volumes that are attached to the VMs as mount points.

MapReduce used with Hadoop (framework for distributed computing) can allow execution of applications which process vast amounts of data (multi-terabyte data-sets) in-parallel on large clusters (thousands of nodes) of commodity hardware in a reliable, fault tolerant manner. A MapReduce job (e.g., as a Hadoop workload) usually splits the input data-set into independent chunks to be processed in parallel manner. The job has two main phases of work—“map” and “reduce”—hence MapReduce. In the “map” phase, the given problem is divided into smaller sub-problems, each mapper then works on the subset of data providing an output with a set of (key, value) pairs (or referred herein as key-value pairs). In the “reduce” phase, the output from the mappers is handled by a set of reducers, where each reducer summarizes the data based on the provided keys. When MapReduce is implemented in a virtualized environment, e.g., using OpenStack cloud infrastructure, the mappers and reducers are provisioned as VMs (sometimes referred to as virtual compute nodes) on physical hosts. Processing these large datasets is computationally intensive, and taking up resources in a data center can be costly.

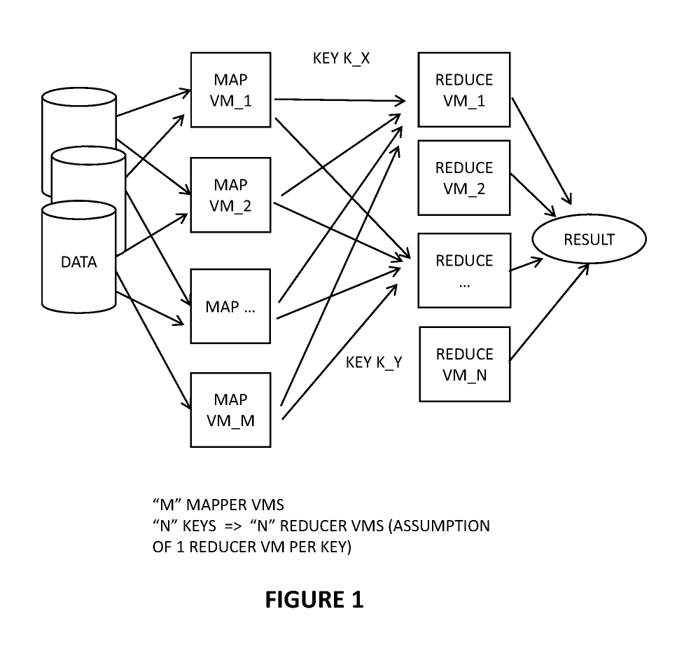

FIG. 1 illustrates the process for MapReduce having map tasks and reducer tasks being performed in a virtualized computing environment, according to some embodiments of the disclosure. First, data is provided to M mapper VMs (shown as MAP VM_1, MAP VM_2, . . . MAP VM_M) to perform the respective mapper tasks. During the MapReduce job, all the map tasks may be completed before reducer tasks start. Once the mapper tasks are complete, output from the mapper VMs can have N keys. For reduce, key-value pairs with the same key ought to end up at (or be placed at/assigned to) the same reducer VM. This is called partitioning. In one example, it is assumed one reducer VM performs reducer task for one key. The example would have N reducer VMs (shown as REDUCE VM_1, REDUCE VM_2, . . . REDUCE VM_N). A MapReduce system usually provides a default partitioning function, e.g., hash(key) mod R to select a reducer VM for a particular key. However, due to the effects of lopsided key distributions, multi-tenancy, network congestion, etc., such a simple partition function can cause some of the reducer VMs to take excessively long time, thus delaying the overall completion of the job. For at least that reason, the placement VMs in a physical topology of hosts/servers and their proper Hadoop task scheduling can play an important role in deciding the performance of such workloads.

The performance of Hadoop workloads is directly impacted by the job completion times of the mapper and reducer tasks. The time taken by tasks is not only related to the host physical node's performance in terms of CPU/Memory availability, but also related to the compute node location and storage node location, as the execution of the Hadoop mapper and reducer tasks involves a lot of data transfer between the nodes where the data is stored in the Hadoop Distributed File System (HDFS) cluster. In terms of a virtualized Hadoop cluster, the nodes used for creating the Hadoop cluster are VMs running on a cluster of physical nodes. In this scenario, where the VMs are placed in the cluster of physical nodes plays an important role in deciding the overall performance of the Hadoop workload, because the network topology and the network factors such as bandwidth and latency have a direct impact on the job completion times of the Hadoop tasks. Hence, while creating a virtualized Hadoop cluster, optimizing performance may need to address about the optimal scheduling of VMs (i.e., optimal placement of VMs in physical nodes) and the optimal scheduling of tasks onto the VMs (i.e., task allocation). Hadoop can supports some task scheduling strategies such as capacity scheduling based on memory and also has data locality strategies to determine which nodes to use for the tasks depending on the data residing in the nodes.

A Unique Two-Part Scheme for Addressing Network Cost

The present disclosure describes a scheme for addressing the issue of network cost when scheduling tasks, e.g., for Hadoop workloads in a virtualized computing environment. Phrased differently, the scheme leverages the knowledge of the network topology and the network cost factors (e.g., bandwidth and latency) between all the physical nodes of the cluster to improve the overall performance of Hadoop workloads. The scheme has two parts. First, the scheme implements an optimal VM placement strategy (e.g., VM placement optimizer, a compute scheduler) for creating the virtualized Hadoop cluster on a physical network topology of physical hosts using network cost aware optimizations, e.g., based on VM co-location or affinity to minimize the potential data transfer costs over the network. Second, the scheme implements an optimized Hadoop task scheduler using network cost aware optimizations, which are currently not used by any Hadoop task schedulers. The task scheduler uses constraint optimization solving techniques using the knowledge of an approximate network cost (determined using factors such as bandwidth, latency, etc.) of all links (between any two nodes of the Hadoop cluster).

The two-part scheme is unique and advantageous for many reasons. Conventional task scheduling do not take into account of network costs and only rely on capacity, where resource-based task scheduling is supported based on a job's memory requirements. In addition to the task scheduling optimization, the two-part scheme ensures that the virtualized Hadoop cluster has an optimal VM placement to begin with (before task scheduling even begins), such that the Hadoop nodes (VMs) have the best bandwidth and latency between them that is possible from the existing underlay of physical hosts server node.

Effectively, the two-part scheme provides a mechanism that improves the overall Hadoop performance, by minimizing the Hadoop job completion time using the network topology and network cost factors such as bandwidth and latency information between the physical nodes of the Hadoop cluster, ensuring optimal Hadoop cluster nodes (optimally placed VMs) are selected for the task execution, and also the best physical nodes used for creating the VMs that form the virtualized Hadoop cluster. The technical task to be achieved is to provide task allocations for each scheduling action aiming to meet one or more of these goals: (1) a data local node that can accommodate a task is picked when possible and available (supporting data locality and resource-based task scheduling mechanisms in Hadoop), and (2) if a data local node is not available, a most optimal node for the current task (i.e., the node which provides the least cost for data transfer of the required data split to the selected node) is selected in terms based on the network costs due to factors such as bandwidth, latency, etc.

An Illustrative Method Based on the Two-Part Scheme

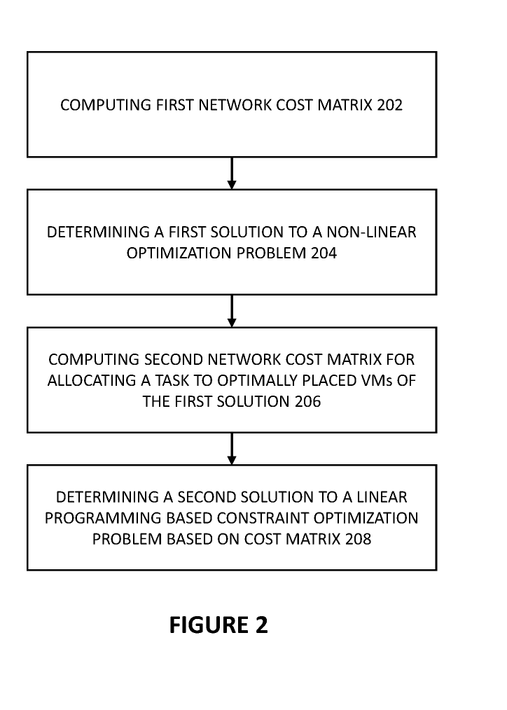

FIG. 2 is a flow diagram which illustrates a method for optimizing task scheduling in an optimally placed virtualized cluster using network cost optimizations, according to some embodiments of the disclosure. For the first part of the two-part scheme, the method comprises computing a first network cost matrix for a plurality of available physical nodes (box 202) and determining a first solution to a first optimization problem of virtual machine placement onto the plurality of available physical nodes based on the first network cost matrix (box 204). The first solution comprises one or more optimally placed virtual machines. For the second part of the two-part scheme, the method comprises computing a second network cost matrix for allocating one or more tasks to one or more possible optimally placed virtual machines of the first solution (box 206) and determining a second solution to a second optimization problem of task allocation onto one or more possible optimally placed virtual machines of the first solution based on the second network cost matrix (box 208).

An Illustrative System for Implementing the Two-Part Scheme

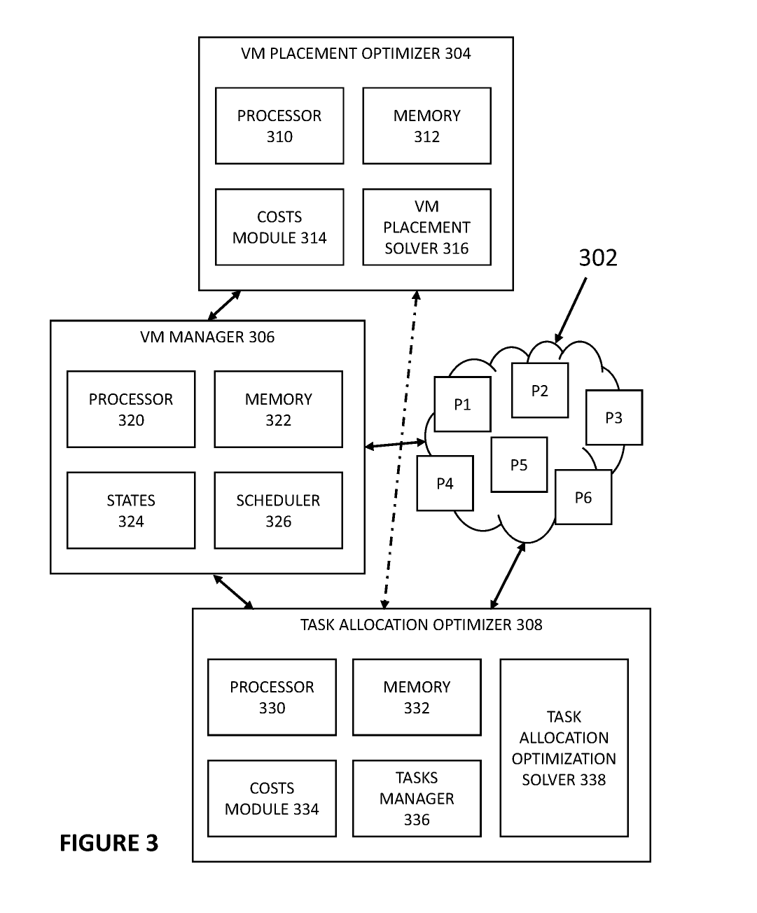

FIG. 3 shows an illustrative system for optimizing task scheduling in an optimally placed virtualized cluster using network cost optimizations, according to some embodiments of the disclosure. The virtual cluster can be implemented on a number of available physical nodes (labeled P1, P2, P3, P4, P5 and P6 in the example) on which VMs can be created to form a virtualized computing environment 302.

Virtual machine placement refers to the process of selecting a particular physical node to create a particular VM (in effect, placing the particular VM onto the selected physical node). Physical nodes, as used herein, are physical hardware servers which have one or more processors and one or more non-transitory computer readable storage/medium. VMs are virtualized instances of machines that are provided by one or more physical nodes. A physical node can provide one or more VMs. Data to be processed are stored in one or more of the physical nodes, possibly as a virtualized block storage volume. A virtualized cluster, as used herein, refers to one or more (compute) virtual machines which can perform tasks. Task scheduling, as used herein (or used interchangeably with “task allocation”), refers to the process of selecting a virtual machine to perform one or more tasks, or assigning a task to a particular virtual machine. Network cost, as used herein, can include one or more of the following: bandwidth availability, cost of bandwidth, latency measurements, link utilization, link health, etc.

To carry out the first part of the two-part scheme, the system seen in FIG. 3 includes a VM placement optimizer 304, which can improve the functionalities of the VM manager 306. The VM manager 306 provides management functionalities for controlling where VMs and/or virtual block storage volumes can be created on the physical hosts to provide the virtualized computing environment 302. Examples of VM manager 306 in Openstack is Nova and Cinder. The VM manager 306 can include a scheduler 326 for managing the VMs and/or virtual volumes and a states module 324 for maintaining properties (or state information) of the physical nodes. The states module 324 can include computing constraints of the physical nodes, network topology information of the physical nodes, and any suitable information usable by the VM placement optimizer 304 to optimize VM placement. The VM placement optimizer 304 can implement the first part of the two-part scheme, by computing a first network cost matrix for a plurality of available physical nodes (e.g., available hosts such as P1, P2, P3, P4, P5, P6, etc.). The computation can be performed by the cost module 314, e.g., based on information maintained by the states module 324 and/or some other data source. The VM placement optimizer 304, e.g., the VM placement solver 316, can further determine a first solution to a first optimization problem of virtual machine placement onto the plurality of available physical nodes based on the first network cost matrix using the VM placement solver 316. The first solution can then be transmitted to the VM manager 306 such that the scheduler 326 can create the optimally placed VMs. If needed, the states module 324 updates the properties of the physical nodes.

To carry out the second part of the two-part scheme, the system seen in FIG. 3 includes a task allocation optimizer 308, which can receive and manage workloads and determine how to best allocate the tasks within the workloads. The task manager 336 can receive workloads and determine tasks needed to complete the workloads. In some embodiments, the task manager 336 can determine the number (and possible types) of optimally placed VMs desired for a particular task, and transmits a request to the VM placement optimizer 304 to find a solution having the desired number (and possible types) of VMs. The task allocation optimizer 308 can receive information about the first solution from the VM manager 306 and/or the VM placement optimizer 304 (e.g., information identifying optimally placed virtual machines). Furthermore, the task allocation optimizer 308 can receive any associated properties of the physical hosts on which the optimally placed VMs of the first solution are created. The costs module 334 can use the received information and/or associated properties to compute a second network cost matrix (and other variables) for allocating one or more tasks to one or more possible optimally placed virtual machines of the first solution. The task allocation optimizer 308, e.g., the task allocation optimization solver 338 can determine a second solution to a second optimization problem of task allocation onto one or more possible optimally placed virtual machines of the first solution based on the second network cost matrix.

First Part of the Two-Part Scheme: Determine Optimally Placed VMs

To find optimally placed VMs, a first network cost matrix is computed based on VM co-location or affinity, such that solving an optimization problem based on the first network cost matrix can try to co-locate the VMs in physical nodes as much as possible to minimize the time taken for data transfer over the network. The VM placement optimization can be viewed as problem as a mathematical constraints optimization problem. The non-trivial formulation of the optimization problem involves defining a cost function, which when minimized, would provide a solution associated with the least network cost. Specifically, the cost function to minimize for optimal VM placement involves computing the network costs such as bandwidth and latency between any two physical nodes. Considering that in a typical Hadoop job, there is a possibility and reasonable expectation for data transfer between any two Hadoop nodes (VMs) in the Hadoop cluster. Accordingly, the network cost of a certain VM placement solution can be estimated or valued by adding up the cost of data transfer between all combinations of the VMs. Based on this insight, the optimization problem is thus formulated as a problem of selecting a subset of available physical hosts, which can be used to create or host the VMs, e.g., for the Hadoop cluster. Due to the nature of the optimization problem, the objective of optimizing co-location of VMs would result in a non-linear optimization problem (e.g., convex optimization).

Suppose there are “p” available physical nodes connected by some network topology in a datacenter that are available for use to create or host virtual machines and “k” node Hadoop cluster is desired. Phrased differently, in a desired virtualized Hadoop environment, “k” VMs are desired or needed. For the sake of simplifying the mathematical formulation (and not to limit the scope of the disclosure), it is assumed that all physical nodes are identical, and that a physical host can create “Vₘₐₓ” VMs. Therefore, if “k” VMs are needed, the optimization problem can solve to maximize the co-location of VMs on “pₓ=[k/Vₘₐₓ]” physical nodes for minimal movement of data over the network. Phrased differently, the objective is to find the best set of “pₓ” physical nodes to create “k” VMs that minimize the net data transfer costs. The set of physical nodes, P=[P₁, P₂, . . . , Pᵢ, . . . Pₚ], comprises a total of “p” available physical nodes. Variables of the optimization problem is X=[x₁, x₂, . . . xᵢ, . . . xₚ] where each xᵢ=1 if the physical node Pᵢ is chosen finally for creating or hosting a VM.

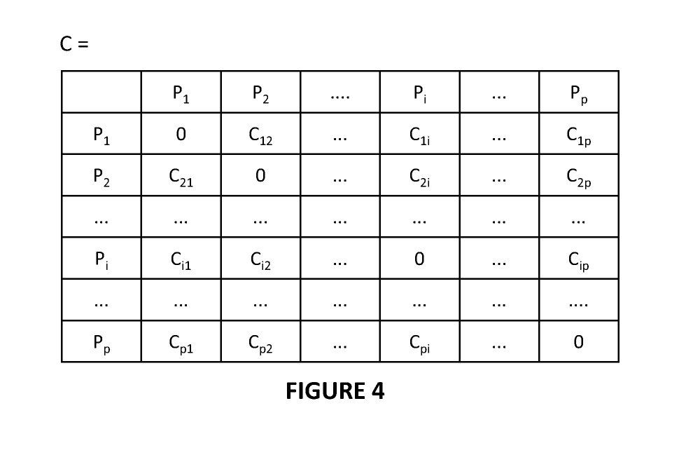

FIG. 4 shows an illustrative cost matrix for a plurality of available physical hosts, according to some embodiments of the disclosure. Rows and columns of the first network cost matrix are both indexed by available physical nodes P=[P₁, P₂, . . . , Pᵢ, . . . Pₚ]. Entries of the first network cost matrix C_{ab} comprises network costs between possible pairs of physical nodes. C_{ab} indicates the network cost between the physical hosts Pₐ and P_{b}. For simplicity (and not to limit the scope of the disclosure), C_{ab}=C_{ba}, and Cᵢᵢ=0.

The objective function to minimize is arrived at by calculating the aggregate network cost of all possible data transfers between the chosen subset of physical hosts of size “pₓ”. Accordingly, determining a solution to the optimization problem can include minimizing an objective function which calculates an aggregate network cost of possible data transfers between a selected subset of physical hosts to determine one or more physical hosts for creating a number of optimally placed virtual machines. For example, if P₁ is part of the chosen set, this contributes the following cost: x₁*(x₂*C₁₂+x₃*C₁₃+ . . . xᵢ*C₁ᵢ+ . . . xₚ*C₁ₚ), i.e., the network cost of data transfer between P₁ and all the other physical hosts that are finally chosen. Whether other physical hosts are chosen or not can be represented by the corresponding xᵢ values (e.g., 0 for not chosen, and 1 for chosen). The variable x₁ indicates whether P₁ is chosen, and hence the network cost contribution is included when value is 1. Similarly P₂ contributes this to the aggregate cost: x₂*(x₁*C₂₁+x₃*C₂₃+ . . . xᵢ*C₂ᵢ+ . . . xₚ*C₂ₚ) and so on. After aggregating all of them, the aggregate cost function results in Sum_{i=[1,p]}(xᵢ*Sum_{j=[1,p]}(xᵢ*Cᵢⱼ)). The objective function is non-linear in nature, and non-linear (convex) optimization solvers can be used to minimize the aggregate cost function.

Because a subset of physical hosts of size “pₓ” is needed, a constraint can be introduced to the non-linear optimization problem. Accordingly, determining a solution to the optimization problem can include minimizing an aggregate network cost of possible data transfers between a selected subset of physical hosts subject to a constraint that a total number of selected subset of physical hosts in the first solution has the capacity to create a desired number of optimally placed virtual machines. Mathematically, the constraint to meet while solving for the variables can be defined as x₁+x₂+ . . . +xᵢ+ . . . xₚ=pₓ, i.e., Sum_{i=[1,p]}=pₓ.

The optimal selection of physical hosts and hence the optimal VM placement is arrived by solving the following nonlinear mathematical constraint optimization problem:

Minimize Sum_{i=[1,p]}(xᵢ*Sum_{j=[1,p]}(xᵢ*Cᵢⱼ))

subject to the constraints:

Sum_{i=[1,p]}=pₓ

Second Part of the Two-Part Scheme: Determine Optimal Task Allocation

To find optimal task allocation, the problem starts with a scenario of an ideally placed virtualized Hadoop cluster from the first part of the two-part scheme. Based on the first solution found from the first part of the two-part scheme, a constraint-optimization based technique is applied for scheduling the tasks in a Hadoop cluster (specified by the first solution) that minimizes the network costs, and hence minimizing the effective job completion time.

Considering that the number of tasks could be much higher than the total number of tasks that is possible to be run simultaneously by all the nodes of the Hadoop cluster, this optimization of task allocation (i.e., selecting the nodes for the tasks) can be performed each time one of more slots become free, and/or at the beginning of the task execution, when the first batch of tasks is to be executed. For a given scheduling decision for a set of tasks to be dispatched or task allocation optimization, to get an optimal solution, the objective is to determine an aggregate network cost in terms of data transfer and try to minimize such cost. The solution would result in the best placement for the set of tasks. When this scheduling optimization is repeated for each set of new tasks, the overall Hadoop job completion time can be reduced, ensuring in each intermediate step of scheduling, a node frees up a slot for a new task faster.

To mathematically formulate this task scheduling constraint optimization problem, consider the first solution from the first part of the scheme resulted in a “k” node Hadoop cluster, with set of “k” virtual nodes: V=[V₁, V₂, . . . , Vᵢ, . . . , Vₖ]. At a particular scheduling step, “t” tasks are to be scheduled: T=[T₁, T₂, . . . Tⱼ, . . . , . . . Tₜ]. In Hadoop job execution, because of components such as the JobTracker, and NameNode, it is possible for a task allocation optimizer to know a priori, the data splits that each of the “t” tasks are operating on, and to know the data split node location (the physical node on which the data split is stored). Accordingly, it is possible do compute a second network cost matrix having aggregate network costs, in terms of the time taken for data transfer between the node where a task gets allocated and the actual location of that data, based on network factors such as bandwidth and latency. For data local placements (currently supported in Hadoop), where a given Hadoop task is dispatched to a node that has the task's designated data split), the network costs can be assumed zero. For all other placements, a network cost of moving data is introduced, which considers the bandwidth and latency.

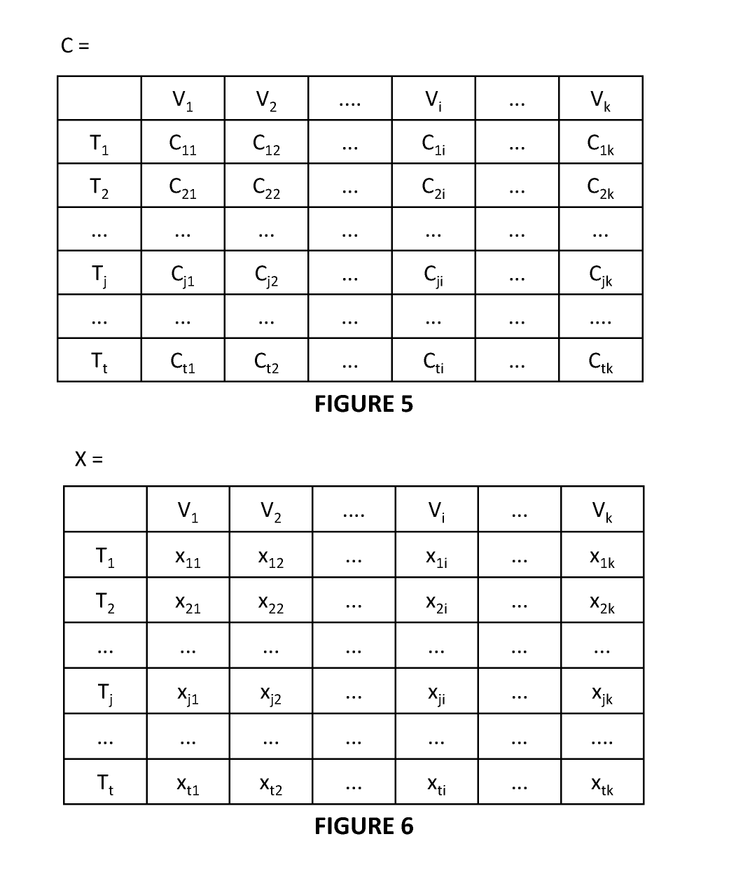

FIG. 5 shows an illustrative cost matrix for allocating one or more tasks to one or more possible optimally placed virtual machines, according to some embodiments of the disclosure. As an example, the rows are the tasks, and the columns are nodes, and the value indicates the cost of allocating the task to that node. Phrased differently, rows and columns of the second network cost matrix are indexed by the one or more optimally placed virtual machines (V=[V₁, V₂, . . . Vᵢ, . . . , Vₖ]) and the one or more tasks (T=[T₁, T₂, . . . Tⱼ, . . . , Tₜ]), and entries of the second network cost matrix C_{ab} comprises network costs, each network cost comprises a measure of data transfer time of moving data from a data split node to a particular physical node having a selected optimally placed virtual machine thereon to perform a particular task. C_{ab} indicates the network cost (e.g., a measure of data transfer time) associated with moving the data split from the data split source node location to node V_{b} for the task Tₐ, considering the task to be allocated to this node. In the second network cost matrix, each row, some cost value will be zero, depending on the data locality, i.e., C_{ab}=0 if the data needed by task Tₐ is located in node V_{b}.

FIG. 6 shows an illustrative variable matrix for allocating one or more tasks to one or more possible optimally placed virtual machines, according to some embodiments of the disclosure. In the variable matrix rows and columns of the variable matrix are indexed by the one or more optimally placed virtual machines (V=[V₁, V₂, . . . Vᵢ, . . . Vₖ]) and the one or more tasks (T=[T₁, T₂, . . . Tⱼ, . . . Tₜ]), and entries of the variable matrix x_{ab}=1 if Task Tₐ is allocated to node V_{b}, and 0 otherwise. Based on the second network cost matrix, determining a second solution to the second optimization problem can include minimizing an objective function which calculates an aggregate network cost for performing the one or more tasks allocated respectively to a selected subset of optimally placed virtual machines. Every variable x_{ab} contributes the cost x_{ab}*C_{ab}, and the aggregate network cost can be computed by taking an aggregate sum for all values of a=[1,t] (all Tasks), and b=[1,k] (all nodes). Accordingly, the aggregate network cost is defined as Sum_{a=[1,t],b=[1,k]}(x_{ab}*C_{ab}).

Besides minimizing the aggregate network cost, determining the solution to the optimization problem involves minimizing the aggregate network cost subject to one or more constraints. For instance, a first constraint can be applied to ensure each one of the one or more optimally placed virtual machine in the second solution has a number of allocated tasks [x₁ᵢ+x₂ᵢ+ . . . xₜᵢ] which is less than or equal to a maximum number of tasks allowed for a particular optimally placed virtual machine. A Constraint set C1 can specify for each node Vᵢ a maximum number of tasks that it can concurrently support based on the resource constraints such as memory requirements, etc. In another instance, a second constraint can be applied to ensure, in the second solution, that a task is allocated to only one optimally placed virtual machine (at a time). A Constraint set C2 can specify for each task Tᵢ, the sum of the row [xⱼ₁+xⱼ₂+xⱼₜ] adds up to exactly 1.

### Constraint set C1:

For every i in [1,k]:
Add constraints:

[x₁ᵢ+x₂ᵢ+xₜᵢ,]<=Nᵢ where “Nᵢ” denotes the maximum number of tasks each node Vᵢ can support

### Constraint set C2:

For every j in [1,t]:
Add constraints:

[xⱼ₁+xⱼ₂+ . . . xⱼₜ]=1

Each task scheduling step can be optimized by solving the following Linear programming (LP) based constraint optimization problem:

Minimize Sum_{a=[1,t],b=[1,k]}(x_{ab}*C_{ab})

subject to constraints:

### 1. Constraint set C1

### 2. Constraint set C2

Unexpected Advantages of the Two-Part Scheme

The two-part scheme has a variety of unexpected advantages. For instance, the combination of the first part and the second part can reduce the complexity of solving the optimization problem of the second part. By initially figuring the best co-located VMs to form a best Hadoop cluster with the best inter-node communication performance (least distance or latency cost), the second part is guaranteed to get the best network optimized task placements as the VMs themselves are selected based on the network cost optimization. In another instance, the Hadoop task scheduler at a particular step has “t” tasks to be scheduled, it is possible to additionally apply a clustering algorithm to find a cluster of at most size “t” with all VMs being nearest neighbors based on the network cost. This can result in a reduced problem space for the second part of the two-part scheme by selecting VMs from a best cluster of max size “t”. In yet another instance, to increase the speed of computing cost matrices and determining solutions to the first part and the second part of the two-part scheme, it is possible to cache or save the network cost estimates or variables (data/information) used in calculating the network costs in the first part for use in the second part (or vice versa), since both the first part and the second part optimizes based on network cost information of the virtualized computing environment.

Variations and Implementations

While the present disclosure describes the creation of VMs, it is possible that one or more VMs may have already been created and thus the “creation” of VMs may mean that the already-existing VMs are selected as optimal and does not require new VMs to be instantiated.

While the present disclosure describes optimizing based on network cost, the optimization problem can be extended in various ways. Examples include adding other constraints based on physical host resource requirements and/or availability, adding other constraints based on task/workload requirements, and adding other cost metrics. To extend the optimization problem, one skilled in the art may, e.g., add further constraints, create further cost matrices, and add further costs to the objective function.

Some of the features described herein extends the features described in U.S. patent application Ser. No. 14/242,131 (describing a framework and solution for optimized VM placements using a constraint-based optimization mechanism) and U.S. patent application Ser. No. 14/509,691 (describing an optimized VM placement strategy which takes into account a key distribution after the mapping phase of Hadoop job execution). Both of these two US patent applications can be applied as extensions to the two-part scheme described herein where appropriate, and are both incorporated herein by reference.

Within the context of the disclosure, a network used herein represents a series of points, nodes, or network elements of interconnected communication paths for receiving and transmitting packets of information that propagate through a communication system. A network offers communicative interface between sources and/or hosts, and may be any local area network (LAN), wireless local area network (WLAN), metropolitan area network (MAN), Intranet, Extranet, Internet, WAN, virtual private network (VPN), or any other appropriate architecture or system that facilitates communications in a network environment depending on the network topology. A network can comprise any number of hardware or software elements coupled to (and in communication with) each other through a communications medium.

As used herein in this Specification, the term ‘network element’ or ‘node’ is meant to encompass any of the aforementioned elements, as well as servers (physical or virtually implemented on physical hardware), machines (physical or virtually implemented on physical hardware), end user devices, routers, switches, cable boxes, gateways, bridges, loadbalancers, firewalls, inline service nodes, proxies, processors, modules, or any other suitable device, component, element, proprietary appliance, or object operable to exchange, receive, and transmit information in a network environment. These network elements may include any suitable hardware, software, components, modules, interfaces, or objects that facilitate the optimization operations thereof. This may be inclusive of appropriate algorithms and communication protocols that allow for the effective exchange of data or information.

In one implementation, managers and optimizers described herein may include software to achieve (or to foster) the functions discussed herein for optimizing task scheduling in an optimally placed virtualized cluster using network cost optimizations where the software is executed on one or more processors to carry out the functions. This could include the implementation of instances of costs modules, VM placement solvers, states modules, schedulers, task allocation optimization solvers, and/or any other suitable element that would foster the activities discussed herein. Additionally, each of these elements can have an internal structure (e.g., a processor, a memory element, etc.) to facilitate some of the operations described herein. Exemplary internal structure includes processor 310, memory element 312, processor 320, memory element 322, processor 330 and memory element 332 of FIG. 3. In other embodiments, these functions for optimization may be executed externally to these elements, or included in some other network element to achieve the intended functionality. Alternatively, managers and optimizers may include software (or reciprocating software) that can coordinate with other network elements in order to achieve the optimization functions described herein. In still other embodiments, one or several devices may include any suitable algorithms, hardware, software, components, modules, interfaces, or objects that facilitate the operations thereof.

In certain example implementations, the optimization functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by one or more processors, or other similar machine, etc.). In some of these instances, one or more memory elements can store data used for the operations described herein. This includes the memory element being able to store instructions (e.g., software, code, etc.) that are executed to carry out the activities described in this Specification. The memory element is further configured to store databases such as cost matrices and data/information associated with network cost estimates disclosed herein. The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving the optimization functions, as outlined herein. Additionally, each of these devices may include a processor that can execute software or an algorithm to perform the optimization activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Additionally, it should be noted that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that the systems described herein are readily scalable and, further, can accommodate a large number of components, as well as more complicated/sophisticated arrangements and configurations. Accordingly, the examples provided should not limit the scope or inhibit the broad techniques of optimizations, as potentially applied to a myriad of other architectures.

It is also important to note that the steps in the FIG. 2 illustrate only some of the possible scenarios that may be executed by, or within, the components shown (e.g., in FIG. 3) and described herein. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the components shown and described herein, in that any suitable arrangements, chronologies, configurations, and timing mechanisms may be provided without departing from the teachings of the present disclosure.

It should also be noted that many of the previous discussions may imply a single client-server relationship. In reality, there is a multitude of servers in the delivery tier in certain implementations of the present disclosure. Moreover, the present disclosure can readily be extended to apply to intervening servers further upstream in the architecture, though this is not necessarily correlated to the ‘m’ clients that are passing through the ‘n’ servers. Any such permutations, scaling, and configurations are clearly within the broad scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method for optimizing task scheduling in an optimally placed virtualized cluster using network cost optimizations, the method comprising:
computing a first network cost matrix for a plurality of available physical nodes;
determining a first solution to a first optimization problem of virtual machine placement onto the plurality of available physical nodes based on the first network cost matrix, wherein the first solution comprises one or more optimally placed virtual machines;
computing a second network cost matrix for allocating one or more tasks to one or more possible optimally placed virtual machines of the first solution; and
determining a second solution to a second optimization problem of task allocation onto one or more possible optimally placed virtual machines of the first solution based on the second network cost matrix.

2. The method of claim 1, wherein the first optimization problem is a non-linear optimization problem.

3. The method of claim 1, wherein:
rows and columns of the first network cost matrix are both indexed by available physical nodes; and
entries of the first network cost matrix comprises network costs between possible pairs of physical nodes.

4. The method of claim 1, wherein determining the first solution comprises:
minimizing an objective function which calculates an aggregate network cost of possible data transfers between a selected subset of physical hosts to determine one or more physical hosts for creating a number of optimally placed virtual machines.

5. The method of claim 1, wherein determining the first solution comprises:
minimizing an aggregate network cost of possible data transfers between a selected subset of physical hosts subject to a constraint that a total number of selected subset of physical hosts in the first solution has the capacity to create a desired number of optimally placed virtual machines.

6. The method of claim 1, wherein the second optimization problem is a linear programming based constraint optimization problem.

7. The method of claim 1, wherein:
rows and columns of the second network cost matrix are indexed by the one or more optimally placed virtual machines and the one or more tasks; and
entries of the second network cost matrix comprises network costs, each network cost comprises a measure of data transfer time of moving data from a data split node to a particular physical node having a selected optimally placed virtual machine thereon to perform a particular task.

8. The method of claim 1, wherein determining the second solution comprises:
minimizing an objective function which calculates an aggregate network cost for performing the one or more tasks allocated respectively to a selected subset of optimally placed virtual machines.

9. The method of claim 1, wherein determining the second solution comprises:
minimizing an aggregate network cost for task allocation subject to one or more constraints.

10. The method of claim 9, wherein the one or more constraints comprises:
a first constraint ensuring each one of the one or more optimally placed virtual machine in the second solution has a number of allocated tasks which is less than or equal to a maximum number of tasks allowed for a particular optimally placed virtual machine.

11. The method of claim 9, wherein the one or more constraints comprises:
a second constraint ensuring, in the second solution, that a task is allocated to only one optimally placed virtual machine.

12. A system for optimizing task scheduling in an optimally placed virtualized cluster using network cost optimizations comprising:
at least one memory element;
at least one processor coupled to the at least one memory element; and
a virtual machine placement optimizer that when executed by the at least one processor is configured to:
compute a first network cost matrix for a plurality of available physical nodes;
determine a first solution to a first optimization problem of virtual machine placement onto the plurality of available physical nodes based on the first network cost matrix, wherein the first solution comprises one or more optimally placed virtual machines;
a task allocation optimizer that when executed by the at least one processor is configured to:
compute a second network cost matrix for allocating one or more tasks to one or more possible optimally placed virtual machines of the first solution; and
determine a second solution to a second optimization problem of task allocation onto one or more possible optimally placed virtual machines of the first solution based on the second network cost matrix.

13. The system of claim 12, wherein:
rows and columns of the first network cost matrix are both indexed by available physical nodes; and
entries of the first network cost matrix comprises network costs between possible pairs of physical nodes.

14. The system of claim 12, wherein determining the first solution comprises:
minimizing an objective function which calculates an aggregate network cost of possible data transfers between a selected subset of physical hosts to determine one or more physical hosts for creating a number of optimally placed virtual machines.

15. The system of claim 12, wherein determining the first solution comprises:
minimizing an aggregate network cost of possible data transfers between a selected subset of physical hosts subject to a constraint that a total number of selected subset of physical hosts in the first solution has the capacity to create a desired number of optimally placed virtual machines.

16. A computer-readable non-transitory medium comprising one or more instructions, for optimizing task scheduling in an optimally placed virtualized cluster using network cost optimizations, that when executed on a processor configure the processor to perform one or more operations comprising:
computing a first network cost matrix for a plurality of available physical nodes;
determining a first solution to a first optimization problem of virtual machine placement onto the plurality of available physical nodes based on the first network cost matrix, wherein the first solution comprises one or more optimally placed virtual machines;
computing a second network cost matrix for allocating one or more tasks to one or more possible optimally placed virtual machines of the first solution; and
determining a second solution to a second optimization problem of task allocation onto one or more possible optimally placed virtual machines of the first solution based on the second network cost matrix.

17. The medium of claim 16, wherein:
rows and columns of the second network cost matrix are indexed by the one or more optimally placed virtual machines and the one or more tasks; and
entries of the second network cost matrix comprises network costs, each network cost comprises a measure of data transfer time of moving data from a data split node to a particular physical node having a selected optimally placed virtual machine thereon to perform a particular task.

18. The medium of claim 16, wherein determining the second solution comprises:
minimizing an objective function which calculates an aggregate network cost for performing the one or more tasks allocated respectively to a selected subset of optimally placed virtual machines.

19. The medium of claim 16, wherein determining the second solution comprises:
minimizing an aggregate network cost for task allocation subject to one or more constraints.

20. The medium of claim 19, wherein the one or more constraints comprises one or more of the following:
a first constraint ensuring each one of the one or more optimally placed virtual machine in the second solution has a number of allocated tasks which is less than or equal to a maximum number of tasks allowed for a particular optimally placed virtual machine; and
a second constraint ensuring, in the second solution, that a task is allocated to only one optimally placed virtual machine.
